(19) United States
(12) Patent Application Publication
(10) Pub. No.: US 2015/0056571 A1
(43) Pub. Date: Feb. 26, 2015

(54) Cross-Fluted Endodontic Instrument

(71) Applicants: Derek Heath, Vero Beach, FL (US); Steve Treadway, Jonesborough, TN (US)

(72) Inventors: Derek Heath, Vero Beach, FL (US); Steve Treadway, Jonesborough, TN (US)

(21) Appl. No.: 13/971,256

(22) Filed: Aug. 20, 2013

(51) Int. Cl. A61C 5/02

(52) U.S. Cl. CPC A61C 5/023
USPC 433/102; 433/224

(57) ABSTRACT

An endodontic instrument adapted to be axially reciprocated within a root canal to remove material from walls of the root canal. The endodontic instrument includes an elongate shaft and a working portion. The elongate shaft includes a proximal end adjacent a handle and a distal end terminating at a tip spaced from the proximal end by the length of the instrument. The working portion includes a first helical fluted cutting surface for removing material from the walls of a root canal and a second helical fluted cutting surface for removing material from the walls of a root canal. The first helical fluted cutting surface and second helical fluted cutting surfaces are formed in opposing left-hand and right-hand directions such that material is removed form the walls of a root canal when the instrument is rotated in either a first or a second direction.

### FIELD

This disclosure relates to the field of endodontics. More particularly, this disclosure relates to instruments used for enlarging and obturating an extirpated root canal.

### BACKGROUND

In the field of endodontics, one of the most important and delicate procedures is that of cleaning or extirpating a diseased root canal to provide a properly dimensioned cavity while essentially maintaining the central axis of the canal for filling of the canal void and capping of the tooth. When done properly, this step enables substantially complete filling of the canal with biologically inert or restorative material without entrapping noxious tissue in the canal that could lead to failure of the therapy.

In a root canal procedure, the dentist removes diseased tissue and debris from the canal prior to filling the canal with a biologically inert or restorative filling material. Many tools and techniques have been designed in an effort to enable dentists to perform the difficult task of cleaning and shaping root canals. Historically, dentists have used endodontic files to remove the soft and hard tissues in and adjacent the root canal. These endodontic files are typically made by grinding helical flutes into a working portion of a small elongate tapered rod to create a curvilinear, abrasive file with a helical cutting edge.

Conventional endodontic instruments with helical cutting/abrading edges have certain endemic problems which, to some degree, have been tolerated and approached from a management perspective rather than an elimination perspective. For example, conventional endodontic instruments may only cut when rotated in one direction. Further, the instruments typically must be backed off after rotating in a first direction to unload the instrument before advancing the instrument further into the root canal Conventional endodontic instruments also may begin to screw into the wall of the canal rather than continuing down the canal toward the apical tip of the root. In some cases, this “screwing in” can cause the instrument to break through the side of the root canal and into surrounding tissue or bone. Or, it may begin to “drift” or displace laterally relative to the center axis of the canal as it is moved roto-axially.

These and other problems continue to plague practitioners and designers alike in their efforts to enlarge and prepare for filling the varied tooth root canal configurations in a manner substantially concentric with the natural or original canal curvature/shape to enable successful, effective and permanent treatment therapies. Accordingly, there is a need for improved endodontic instrument designs and methods that will avoid, minimize or eliminate drawbacks and problems associated with conventional endodontic instruments including, but not limited to, “screwing in” issues and the inability to cut in more than one direction encountered during the use of conventional endodontic instruments.

### SUMMARY

The above and other needs are met by a cross-fluted endodontic instrument. In one aspect, the cross fluted endodontic instrument includes an elongate shaft and a working portion. The elongate shaft includes a proximal end adjacent a handle adapted to be gripped by the hand of a user for being operated by hand or a fitting portion for connection to a dental handpiece for being mechanically operated by mechanism of the handpiece and a distal end terminating at a tip spaced from the proximal end by the length of the instrument. The working portion is adjacent the distal end of the elongate shaft and includes a first helical fluted cutting surface for removing material from walls of the root canal and a second helical fluted cutting surface for removing material from walls of the root canal. The first helical fluted cutting surface and second helical fluted cutting surfaces are formed in opposing left-hand and right-hand directions such that material is removed form walls of the root canal when the instrument is rotated in either a first or a second direction.

In one embodiment, the overall taper of the working portion is from about 0.02 mm/mm to about 0.12 mm/mm. In another embodiment, the elongate shaft has a substantially uniform cross-sectional diameter from the proximal end to the distal end of the elongate shaft.

In yet another embodiment, the working portion of the instrument has a length of from about 3 mm to about 16 mm.

In one embodiment the instrument further includes one or more land cutting surfaces formed on the working portion of the instrument, the one or more land cutting surfaces formed adjacent one or more polygonal lands positioned between the first helical fluted cutting surface and the second helical fluted cutting surface.

In another embodiment, the first helical fluted cutting surface has a helix pitch angle of from about 15° to about 75°. In yet another embodiment, the second helical fluted cutting surface has a helix pitch angle of from about −15° to about −75°.

In one embodiment, the working portion further comprises a third helical fluted cutting surface. In another embodiment, the third helical fluted cutting surface is formed in a left-hand direction substantially parallel to the first helical fluted cutting surface. In yet another embodiment, the third helical fluted cutting surface is formed in a right-hand direction substantially parallel to the second helical fluted cutting surface.

In one embodiment, the first helical fluted cutting surface and second helical fluted cutting surface extend from the distal end of the elongate shaft to the proximal end of the elongate shaft. In another embodiment, the first helical fluted cutting surface and second helical fluted cutting surface extend from the distal end of the elongate shaft to the proximal end of the elongate shaft and the third helical fluted cutting surface extends from the distal end of the elongate shaft along a partial length of the working portion of the instrument.

In one embodiment, the elongate rod is formed of a material selected from the group consisting of stainless steel and nickel-titanium.

In another embodiment, the first helical fluted cutting surface and the second helical fluted cutting surface have a shaped profile that is the same.

In a second aspect, a cross-fluted instrument is provided including an elongate shaft and a working portion. The elongate shaft includes a proximal end adjacent a handle adapted to be gripped by the hand of a user for being operated by hand or a fitting portion for connection to a dental handpiece for being mechanically operated by mechanism of the handpiece and a distal end terminating at a tip spaced from the proximal end by the length of the instrument. The working portion is adjacent the distal end of the elongate shaft and includes one or more helical fluted cutting surfaces for removing material from the walls of the root canal and one or more polygonal lands formed between the one or more helical fluted cutting surfaces, the one or more polygonal lands comprising one or more land cutting surfaces formed along an edge of the one or more polygonal lands. The one or more land cutting surfaces remove materials from the walls of a root canal when the instrument is reciprocated within the root canal.

In one embodiment, the first helical fluted cutting surface and second helical fluted cutting surfaces are formed in opposing left-hand and right-hand directions. In another embodiment, the working portion further comprises a third helical fluted cutting surface.

In a third aspect, a method is provided for removing material from a root canal of a tooth using an endodontic instrument. The endodontic instrument includes an elongate shaft and a working portion. The elongate shaft includes a proximal end adjacent a handle adapted to be gripped by the hand of a user for being operated by hand or a fitting portion for connection to a dental handpiece for being mechanically operated by mechanism of the handpiece and a distal end terminating at a tip spaced from the proximal end by the length of the instrument. The working portion is adjacent the distal end of the elongate shaft and includes a first helical fluted cutting surface for removing material from walls of the root canal and a second helical fluted cutting surface for removing material from walls of the root canal. The method comprises reciprocating the endodontic instrument in an alternating counterclockwise and clockwise rotational direction to extirpate material from walls of the root canal when the endodontic instrument rotates in both the counterclockwise and clockwise rotational directions.

In one embodiment the endodontic instrument further comprises one or more polygonal lands formed between the first helical fluted cutting surface and second helical fluted cutting surface on the working portion of the instrument, the method further comprising reciprocating the endodontic instrument in axial direction parallel with the length axis of the root canal of a tooth to further extirpate material from walls of the root canal.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a perspective view of a cross-fluted endodontic instrument according to one embodiment of the disclosure;

FIG. 2 shows a side view of a cross-fluted endodontic instrument according to one embodiment of the disclosure;

FIG. 3 illustrates a close-up side view of a cross-fluted endodontic instrument according to one embodiment of the disclosure;

FIGS. 4 and 5 show a close-up side view of a cross-fluted instrument according to one embodiment of the disclosure; and

FIG. 6 illustrates a cross-fluted instrument inserted into a root canal of a tooth according to one embodiment of the disclosure.

### DETAILED DESCRIPTION

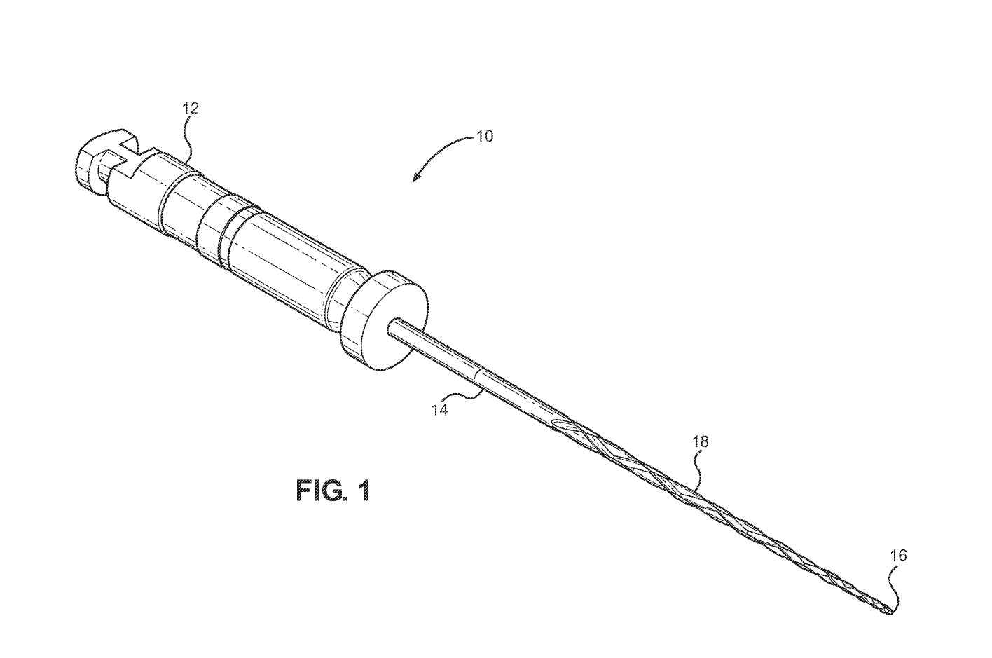

FIG. 1 illustrates features of a cross-fluted endodontic instrument 10 according to one embodiment of the present disclosure. The elongate instrument is preferably formed from an elongate rod of stainless steel or nickel-titanium alloy having a diameter of from about 0.3 millimeters to about 1.6 millimeters, although the rod may have a larger or smaller diameter and/or a varying diameter along its length as needed. In suitable embodiments, rods made from other suitable metals and/or alloys may be used. In one embodiment, the instrument is formed from a controlled memory material allowing the instrument to be pre-formed before inserting the instrument into a root canal.

A fitting portion 12 is secured to a proximal end of the instrument 10 to for mating with the chuck of a dental handpiece. The fitting portion may include a generally I-shaped flat side which defines a step and a generally semicircular disk above and adjacent to a generally semi-circular groove. Such a fitting is typical of those employed in the dental industry for connecting or interfacing a dental tool with a dental drill or handpiece. In other embodiments, the fitting may be modified for connecting or interfacing with non-typical or other types of dental tools. In another embodiment, the fitting portion 12 may be formed of a handle to facilitate hand manipulation of the instrument 10.

The instrument 10 includes an elongate shaft 14 extending from adjacent the fitting portion 12 to adjacent a distal tip end 16 of the instrument 10. The shaft 14 includes a working portion 18 extending from adjacent the distal tip end of the instrument 16 along the length of the shaft 14. The working portion 18 preferably has a length of from about 3 millimeters to about 16 millimeters from the distal tip end 16 along the length of the shaft 14. The diameter of the working portion 18 of the instrument 10 preferably tapers at a rate of from about 0.02 mm/mm to about 0.12 mm/mm, however it is also understood that the diameter of the working portion 18 may be substantially constant along a length of the working portion 18 and/or vary along a length of the working portion.

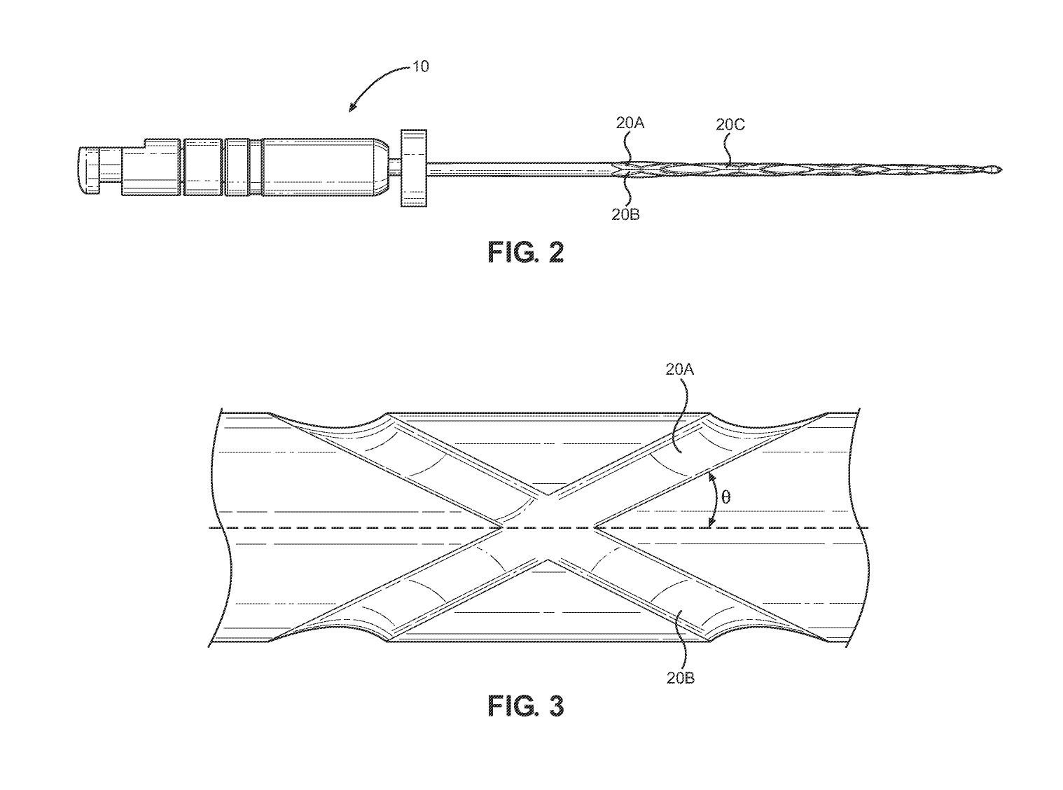

The working portion 18 of the instrument 10 includes two or more helical flutes 20 formed along a surface of the working portion 18. Referring to FIG. 2, the instrument 10 includes at least a first helical flute 20A and a second helical flute 20B formed along the working portion 18 of the instrument 10. The first helical flute 20A is formed in a left-hand helical direction and the second helical flute 20B is formed in a right-hand helical direction.

As referred to herein, the term right-hand helical direction is defined such that to an observer looking down a lengthwise axis of the working portion 18 of the instrument 10 toward the distal tip end 16 of the instrument 10, the flute would move away from the observer in a clockwise direction. Similarly, the term left-hand helical direction is defined such that to an observer looking down a lengthwise axis of the working portion 18 of the instrument toward the distal tip end 16 of the instrument 10, the flute would move away from the observer in a counterclockwise direction.

Referring to FIG. 3, the first helical flute 20A preferably has a helix pitch angle θ of from about 15° to about 75°. The second helical flute 20B preferably has a helix pitch angle of from about −15′ to about −75°. In one embodiment, the first helical flute 20A and second helical flute 20B have substantially equivalent positive and negative pitch angles, however it is also understood that the first helical flute 20A and second helical flute 20B may have varying pitch angles with respect to one another. As referred to herein, the helix pitch angle refers to the angle between the helical flutes 20A and 20B and a central axis of the working portion 18 of the instrument, as illustrated in FIG. 3. In one example, the first helical flute 20A has a helix pitch angle θ of approximately 45° while the second helical flute 20B has a pitch angle of −45°. Alternatively, the pitch angles may vary with respect to one another, the first helical flute may have a pitch angle of approximately 60°, while the second helical flute has a pitch angle of −30°.

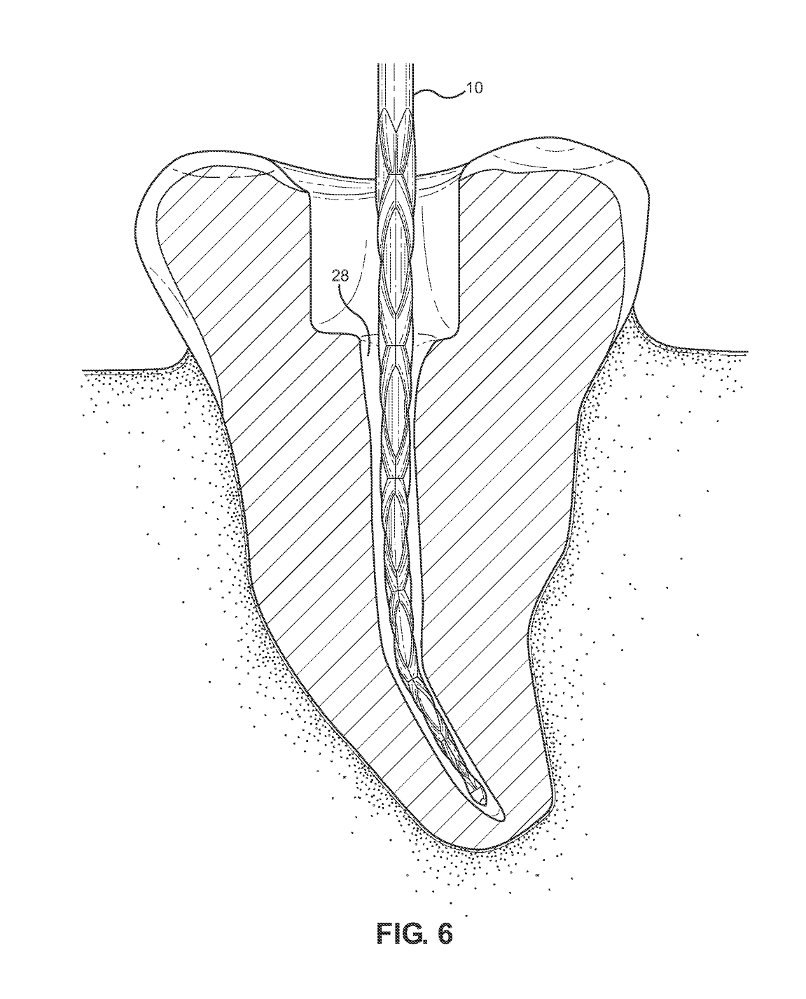

The first helical flute 20A formed in a left-hand helical direction and second helical flute 20B formed in a right-hand helical direction intersect one or more times along a length of the working portion 18 of the instrument 10 forming a plurality of polygonal lands 22. For example, the polygonal lands 22 may be formed into one or more triangles, quadrilaterals or other various polygons. The working portion 18 of the instrument 10 may include multiple types of polygonal lands 22 such as one or more triangles and one or more quadrilaterals. The polygonal lands 22 include one or more land cutting surfaces 24 formed along an edge of the plurality of polygonal lands 22 as shown in FIG. 5. The one or more land cutting surfaces 24 are formed from edges of the first helical flute 20A and second helical flute 20B. In one embodiment, cutting surfaces 24 are formed along each edge of the polygonal lands 22.

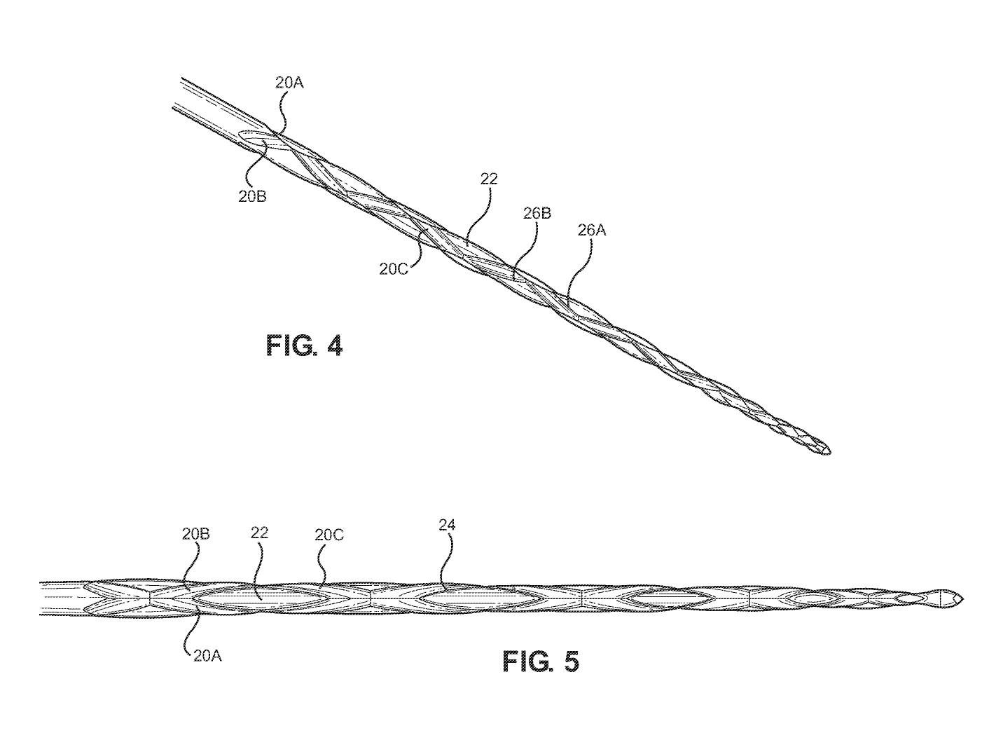

Referring again to FIG. 4, the first helical flute 20A includes a left-hand fluted cutting surface 26A formed along an edge of the first helical flute 20A and the second helical flute 20B includes a right-hand fluted cutting surface 26B formed along an edge of the second helical flute 20B. The left-hand fluted cutting surface 26A is configured such that when the instrument 10 is rotated in a counter-clockwise direction within a root canal, the left-hand fluted cutting surface 26A contacts an inner surface of the root canal to remove material within the root canal. Likewise, the right-hand fluted cutting surface 26B is configured such that when the instrument is rotated in a clockwise direction within a root canal, the right-hand fluted cutting surface 26B contacts an inner surface of the root canal to remove material within the root canal.

The left-hand fluted cutting surface 26A and right-hand fluted cutting surface 26B flutes 20A and 20B may have a shaped profile based on desired cutting characteristics of the instrument 10. For example, the fluted cutting surfaces 26A and 26B may have a positive or negative rake angle to create different cutting characteristics based on a desired characteristic of the instrument 10. The fluted cutting surfaces 26A and 26B may have the same profile such that the instrument 10 has the same cutting characteristics when rotated in both the clockwise and counterclockwise direction. Alternatively, the fluted cutting surfaces 26A and 26B may have different profiles such that the instrument 10 has different cutting characteristics when rotated in the clockwise and counterclockwise directions.

In one embodiment, the cross-fluted endodontic instrument 10 includes a third helical flute formed in the working portion 18 of the instrument 10. The third helical flute may be formed in either left-hand helical direction or a right-hand helical direction such that the working portion 18 includes two left-hand helical flutes or two right-hand helical flutes. The third helical flute may extend a long the full length of the working portion 18 of the instrument or, alternatively, the third helical flute may only extend along a partial length of the working portion 18 such as along a portion of the tip of the working portion 18 such that the instrument 10 has a more aggressive cutting profile along the initial length of the working portion 18 of the instrument.

The third helical flute has a helix pitch angle that is substantially equivalent to the first helical flue or the second helical flute. In an alternative embodiment, the third helical flute has a helix pitch angle that varies from either the first helical flute or the second helical flute.

The cross-fluted endodontic instrument 10 of the present disclosure enables an operator to cut and remove material from a root canal when the instrument 10 is moved in multiple directions without the need to stop and remove the instrument 10 from a root canal. A traditional reciprocating instrument removes material when the instrument is rotated in a first direction but requires that the instrument be reversed to unload the instrument before again advancing the instrument.

With reference to FIG. 6, the instrument 10 is inserted into a root canal 28 and reciprocated within the root canal 28 to remove diseased tissue and debris from the root canal and to otherwise shape the root canal. The instrument 10 is rotationally reciprocated in alternating directions within the root canal. In one embodiment, the instrument is rotationally reciprocated an equal amount in both directions, such as rotating 30° counterclockwise and 30° clockwise. Alternatively, the instrument 10 may be rotationally reciprocated varying amounts for each direction, such as 120° counterclockwise and 60° clockwise, or vice versa.

The cross-fluted endodontic instrument 10 removes material when the instrument is reciprocated in multiple directions within a root canal as illustrated in FIG. 6. When the endodontic instrument 10 is rotated in a counterclockwise direction, the left-hand fluted cutting surface 26A of the first helical flute 20A removes material from a root canal as the left-hand fluted cutting surface 26A contacts the root canal. When the endodontic instrument is rotated in a clockwise direction, the right-hand fluted cutting surface 2613 of the second helical flute 20B removes material from the root canal as the right-handed cutting surface 26B contacts the root canal, thereby allowing the instrument 10 to remove material in both the clockwise and counterclockwise directions. By reciprocating the instrument 10 within the root canal, the first helical flute 20A and second helical flute 20B remove material from the root canal when the instrument is rotated in both the clockwise and counterclockwise direction without requiring the instrument 10 to be removed from the root canal. The one or more land cutting surfaces 24 formed from the edges of the first helical flute 24A and second helical flute 24B also contact a wall of the root canal while the instrument 10 is reciprocated, further removing material while the instrument is reciprocated in multiple directions.

In another embodiment, the cross-fluted endodontic instrument 10 is axially reciprocated in a push and pull method wherein the instrument 10 is substantially inserted into the root canal and subsequently withdrawn from the root canal. By operating the instrument 10 in a push and pull method, material within the root canal is removed by the one or more land cutting surfaces 24 as one or more land cutting surfaces 24 contact the wall of the root canal while the instrument is reciprocated in a push and pull method within the root canal.

One particular advantage of the instrument 10 of the present disclosure is that the first helical flute 20A and opposing second helical flute 20B give the instrument 10 a neutral feed rate, meaning the instrument 10 must be advanced by the operator and will resist “screwing in” to the root canal, and thereby reducing the torsional load on the instrument and reducing the risk of the instrument breaking within the root canal.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. An endodontic instrument adapted to be axially reciprocated within a root canal to remove material from walls of the root canal comprising:
a unitary, one-piece elongate shaft consisting essentially of stainless steel or a nick-titanium alloy, the elongate shaft including
a proximal end adjacent a handle adapted to be gripped by the hand of a user for being operated by hand or a fitting portion for connection to a dental handpiece for being mechanically operated by mechanism of the handpiece and
a distal end terminating at a tip spaced from the proximal end by the length of the instrument,
wherein the elongate shaft comprises a working portion adjacent the distal end of the elongate shaft, the working portion comprising:
a first helical flute extending in a left hand direction along the elongate shaft;
a second helical flute extending in a right hand direction along the elongate shaft;
a polygonal land positioned between the first helical flute and the second helical flute, the polygonal land comprising a first land cutting surface along a first edge adjacent the first helical flute and a second land cutting surface along a second edge adjacent the second helical flute, wherein the first land cutting surface and second land cutting surface are formed in opposing left-hand and right-hand directions such that material is removed from walls of the root canal when the instrument is rotated in either a first or a second direction, and further wherein the polygonal land extends axially from the central axis the same distance as the first and second land cutting surfaces.

2. The endodontic instrument of claim 1, wherein an overall taper of the working portion is from about 0.02 mm/mm to about 0.12 mm/mm.

3. (canceled)

4. The endodontic instrument of claim 1, wherein the working portion of the instrument has a length of from about 3 mm to about 16 mm.

5. (canceled)

6. The endodontic instrument of claim 1, wherein the first flute has a helix pitch angle of from about 15° to about 75°.

7. The endodontic instrument of claim 1, wherein the second flute has a helix pitch angle of from about −15° to about −75°.

8. The endodontic instrument of claim 1, wherein the working portion further comprises a third helical flute.

9. The endodontic instrument of claim 8, wherein the third helical flute is formed in a left-hand direction substantially parallel to the first helical flute.

10. The endodontic instrument of claim 8, wherein the third helical flute is formed in a right-hand direction substantially parallel to the second helical flute.

11. The endodontic instrument of claim 1, wherein the first helical flute and second helical flute extend from the distal end of the elongate shaft to the proximal end of the elongate shaft.

12. The endodontic instrument of claim 8, wherein the first helical flute and second helical flute extend from the distal end of the elongate shaft to the proximal end of the elongate shaft and the third helical flute extends from the distal end of the elongate shaft along a partial length of the working portion of the instrument.

13. (canceled)

14. The endodontic instrument of claim 1, wherein the first land cutting surface and the second land cutting surface have a shaped profile that is the same.

15. An endodontic instrument adapted to be axially reciprocated within a root canal to remove material from walls of the root canal comprising:
a unitary, one-piece elongate shaft consisting essentially of stainless steel or a nick-titanium alloy, the elongate shaft including:
a proximal end adjacent a handle adapted to be gripped by the hand of a user for being operated by hand or a fitting portion for connection to a dental handpiece for being mechanically operated by mechanism of the handpiece and
a distal end terminating at a tip spaced from the proximal end by the length of the instrument,
wherein the elongate shaft comprises a working portion adjacent the distal end of the elongate shaft, the working portion comprising:
one or more helical flutes;
one or more polygonal lands formed between the one or more helical flutes, the one or more polygonal lands comprising land cutting surfaces formed along each edge of the one or more polygonal lands at intersections of the polygonal lands and the one or more helical flutes, wherein the polygonal lands extend axially from the central axis the same distance as the land cutting surfaces;
wherein the one or more land cutting surfaces remove materials from walls of the root canal when the instrument is reciprocated within the root canal.

16. The endodontic instrument of claim 15 wherein the one or more helical flutes comprise a first helical flute and a second helical flute that are formed in opposing left-hand and right-hand directions.

17. The endodontic instrument of claim 16, wherein the working portion further comprises a third helical flute.

18. A method for removing material from a root canal of a tooth using an endodontic instrument:
the endodontic instrument comprising
a unitary, one-piece elongate shaft consisting essentially of stainless steel or a nick-titanium alloy, the elongate shaft including
a proximal end adjacent a handle adapted to be gripped by the hand of a user for being operated by hand or a fitting portion for connection to a dental handpiece for being mechanically operated by mechanism of the handpiece and
a distal end terminating at a tip spaced from the proximal end by the length of the instrument,
the elongate shaft comprising a working portion adjacent the distal end of the elongate shaft, the working portion comprising:
a first helical flute extending in a left hand direction along the elongate shaft;
a second helical flute extending in a right hand direction along the elongate shaft;
a polygonal land positioned between the first helical flute and the second helical flute, the polygonal land comprising a first land cutting surface along a first edge adjacent the first helical flute and a second land cutting surface along a second edge adjacent the second helical flute, wherein the first land cutting surface and second land cutting surface are formed in opposing left-hand and right-hand directions such that material is removed from walls of the root canal when the instrument is rotated in either a first or a second direction, and further wherein the polygonal land extends axial from the central axis the same distance as the first and second land cutting surfaces.

19. The method of claim 18, wherein the method further comprises reciprocating the endodontic instrument in an axial direction parallel with a length axis of the root canal of a tooth to further extirpate material from walls of the root canal.
